(19) United States
(12) Patent Application Publication
(10) Pub. No.: US 2015/0375854 A1
(43) Pub. Date: Dec. 31, 2015

(54) DIFFERENTIAL STEERING CONTROL OF ELECTRIC TAXI LANDING GEAR

(71) Applicant: HONEYWELL INTERNATIONAL INC., Morristown, NJ (US)

(72) Inventors: Stephen Abel, Chandler, AZ (US); David Lazarovich, Thornhill (CA); Joseph Nutaro, Phoenix, AZ (US)

(73) Assignee: HONEYWELL INTERNATIONAL INC., Morristown, NJ (US)

(21) Appl. No.: 14/317,112

(22) Filed: Jun. 27, 2014

(51) Int. Cl. B64C 25/40; G05D 1/00

(52) U.S. Cl. CPC B64C 25/405; G05D 1/0083

(57) ABSTRACT

An aircraft taxi control system may include a left main gear (MG) drive motor, a right MG motor, a first motor drive controller configured to produce a left motor torque signal responsively to nose gear angle (NGA) and nose wheel speed (NGS), and a second motor drive controller configured to produce a right motor toque signal responsively to the NGA and the NGS. The left motor torque signal and the right motor torque signal may be coordinated to reduce lateral loading of the nose wheel during a turning maneuver.

### BACKGROUND OF THE INVENTION

The present invention generally relates to steering an aircraft during ground-based operations. More particularly, the invention relates to control of main landing gear wheel speeds to facilitate and improve nose wheel steering when an aircraft is propelled with an electric taxi system (ETS).

Conventional engine thrust taxiing uses the nose gear exclusively to steer the aircraft (at low speed). Turning requires the massive aircraft to accelerate in the yaw axis. This is precipitated by creating and sustaining a side load at the nose gear which arises after the nose gear is turned. It is generally too cumbersome to differentially control engine thrust for this purpose (the engine response is relatively slow compared to the steering response). Aside from yaw acceleration, turning wheels themselves cause a resisting torque. A loaded rolling wheel even produces resistance since the contacting surface has to continually deform as it loads and unloads (surface spreading). A turning wheel is subject to even more deformation since the outboard fibers must travel farther than the inboard fibers. This effect is called “scrubbing”, “scuffing” or “creep”.

All these actions require power to sustain. The relationship between speed, load, inflation and turning radius can be determined by test. A simple electric taxi system operates like an engine system where equal torque is applied to one designated wheel of the left and right main gear.

As can be seen, there is a need for an improved taxi control system to provide for steering of an aircraft with reduced lateral loading of a nose wheel resulting from yaw acceleration.

### SUMMARY OF THE INVENTION

In one aspect of the present invention, an aircraft taxi control system may comprise: a left main gear (MG) motor; a right MG motor; a first motor drive controller configured to produce a left motor torque signal responsively to nose gear angle (NGA) and nose wheel speed (NGS); and a second motor drive controller configured to produce a right motor torque signal responsively to the NGA and the NGS, said left motor torque signal and said right motor torque signal being coordinated to reduce lateral loading of the nose wheel during a turning maneuver.

In another aspect of the present invention, a method for turning an aircraft during taxiing may comprise the steps: driving a left MG motor at a first speed; driving a right MG motor at a second speed; and varying the first speed relative to the second speed responsively to NGA and NGS to reduce lateral loading of a nose wheel resulting from yaw acceleration of the aircraft during a turning maneuver.

In still another aspect of the present invention, a method for controlling an aircraft during ground based operation may comprise the steps: producing a motor torque command (MTC) from a nose gear speed command (NGC); producing a nose gear angle command (NGA); applying the MTC and the NGA to a speed ratio table to produce a left torque command (LTC) and a right torque command (RTC) as a function of aircraft geometry; producing a left MG torque application command; producing a right MG torque application command; driving a left MG motor responsively to the left MG torque application command; and driving a right MG motor responsively to the right MG torque application command, so that the aircraft turns responsively to the NGA command with reduced lateral loading of the nose wheel resulting from yaw acceleration of the aircraft.

These and other features, aspects and advantages of the present invention will become better understood with reference to the following drawings, description and claims.

### BRIEF DESCRIPTION OF THE DRAWINGS

FIG. 1 is a block diagram of a taxi control system for an aircraft in accordance with an exemplary embodiment of the invention;

FIG. 2 is a diagram of an operational feature of the system of FIG. 1 in accordance with an exemplary embodiment of the invention;

FIG. 3 is a diagram of a second operational feature of the system of FIG. 1 in accordance with an exemplary embodiment of the invention;

FIG. 4 is a graph showing a relationship between nose wheel speed and main gear wheel speed in accordance with an exemplary embodiment of the invention;

FIG. 5 is a diagram of various dimensional characteristics of an aircraft;

FIG. 6 is a flow chart of a method for turning an aircraft during taxiing in accordance with an exemplary embodiment of the invention; and

FIG. 7 is a flow chart of a method for controlling an aircraft during ground based operation in accordance with an exemplary embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention generally provides an aircraft taxi control system in which differential torque may be applied to main gear wheels in order to impart yaw torque on the aircraft and reduce side loading on a nose gear wheel. More particularly, torque compensation may be derived from knowledge of the nose gear steering angle and landing gear geometry.

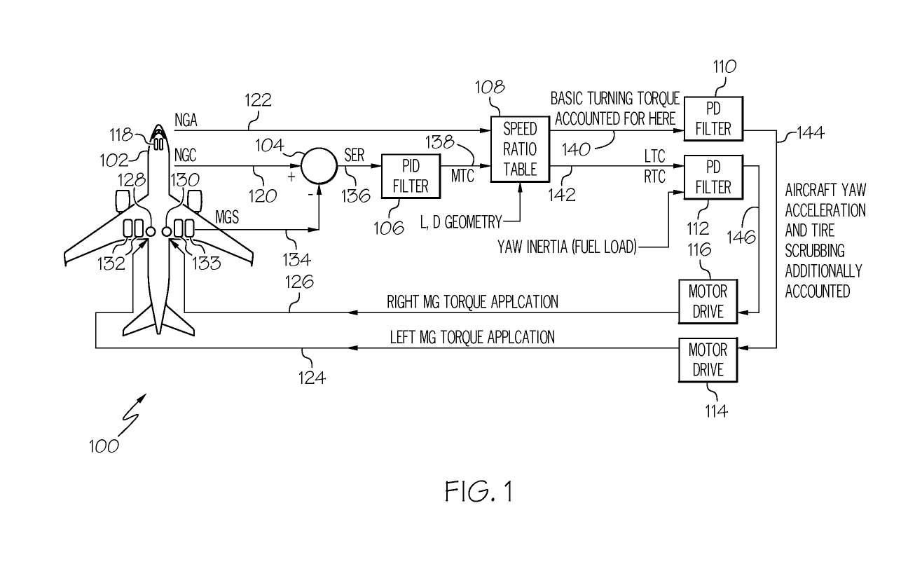

Referring now to FIG. 1, a schematic diagram illustrates an exemplary embodiment of steering control system 100 for an aircraft 102 equipped with an electric taxi system (ETS). The system may include, among other things, a speed error summer 104, a proportional-integral-differential (PID) filter 106, a speed ratio table 108, a left side proportional differential (PD) filter 110, a right-side PD filter 112, a left side motor drive controller 114 and a right side motor drive controller 116. In an exemplary mode of operation, a pilot of the aircraft 102 or an automated taxi speed controller (not shown) may provide a taxi speed command which may define a desired speed for nose wheel 118 of the aircraft. For purposes of simplicity, such a command may be referred to hereinafter as nose gear command (NGC) 120. Additionally, the pilot of the aircraft 102 or an automated taxi guidance controller (not shown) may provide a steering command which may define a desired angle for the nose wheel(s) 118. For purposes of simplicity, such a command may be referred to hereinafter as nose gear angle (NGA) 122.

The system 100 may employ the NGC 120 and the NGA 122 to develop and apply a left main gear (MG) torque signal 124 to a left MG drive motor 128. The system 100 may also develop and apply a right MG torque application signal 126 to a right MG drive motor 130. As explained later hereinbelow, the signals 124 and 126 may be developed and applied so that the aircraft 102 may be steered with minimal lateral loading of the nose wheel(s) 118 and with minimal energy imparted to main gear drive wheels 132 and 133.

In operation, the summer 104 may receive NGC 120 and a main gear speed signal (MGS) 134 and produce a speed error signal (SER) 136. The SER 136 may be applied to the PID filter 106 and the PID fitter 106 may produce a motor torque command (MTC) 138. The speed ratio table 108 may be employed to determine a left turning torque command (LTC) 140 and a right turning torque command (RTC) 142. The LTC 140 and RTC 142 may be derived from the table 108 as functions of the NGA 120, the MTC 138 and various parameters relating to aircraft geometry. The LTC 140 and the RTC 142 may account for basic turning torque (as explained later hereinbelow). The LTC 140 may be applied to the PD filter 110 and a left drive signal 144 may be provided from the filter 110 to the left motor drive controller 114. Similarly, the RTC 142 may be applied to the PD filter 112 and a right drive signal 146 may be provided from the PD filter 112 to the right motor drive controller 116. The drive signals 144 and 146 may account for aircraft yaw acceleration and tire scrubbing (as explained later hereinbelow).

Responsively to the drive signals 144 and 146, the motor drive controllers 114 and 116 may provide the MG torque application signals 124 and 126 to the motors 128 and 130. The MG torque application signals 124 and 126 may vary as needed so that the aircraft 102 may be steered with minimal lateral loading of the nose wheel(s) 118 and with minimal energy imparted to main gear drive wheels 132 and 133.

It may be noted that aircraft speed is referenced at the nose wheel 118. This has two advantages. One is that the pilot can relate best to nose wheel speed since that is near where he or she operates, and the other is that a singularity is avoided for the case of 90 degree nose gear angle where ground speed becomes zero even though the nose wheel and the pilot are in motion.

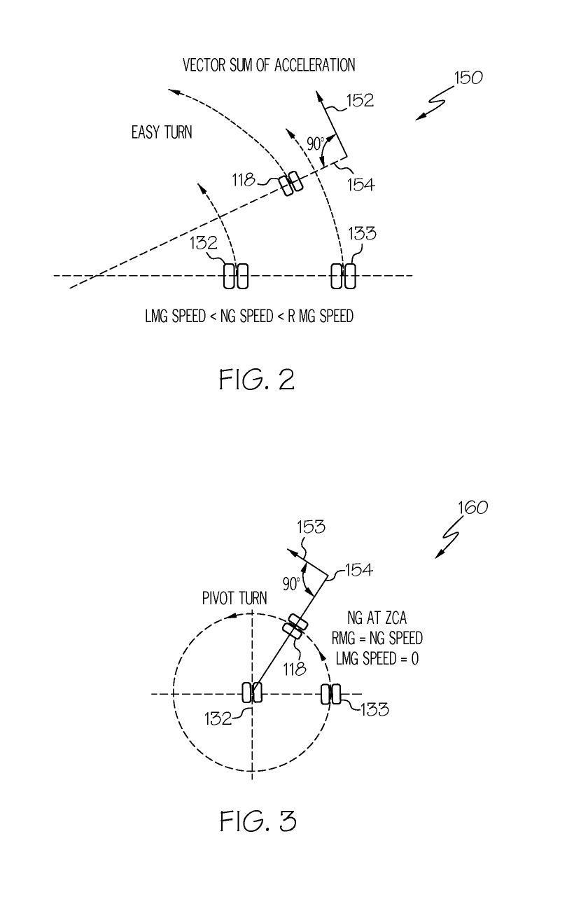

Referring now to FIG. 2, a diagram 150 illustrates interactions of the nose wheel 118 and the MG wheels 132 and 133 during a wide turn maneuver performed in accordance with an exemplary embodiment of the invention. An acceleration indicator line 152 may represent a vector sum of axial and yaw acceleration of the nose wheel 118. The acceleration indicator line 152 is illustrated in an orientation that is orthogonal to an axis 154 of the nose wheel 118. In other words, the relative speeds of the left MG and right MG may be controlled so that the nose wheel 118 may not be subjected to any axial (i.e., lateral) forces resulting from axial or yaw acceleration of the aircraft.

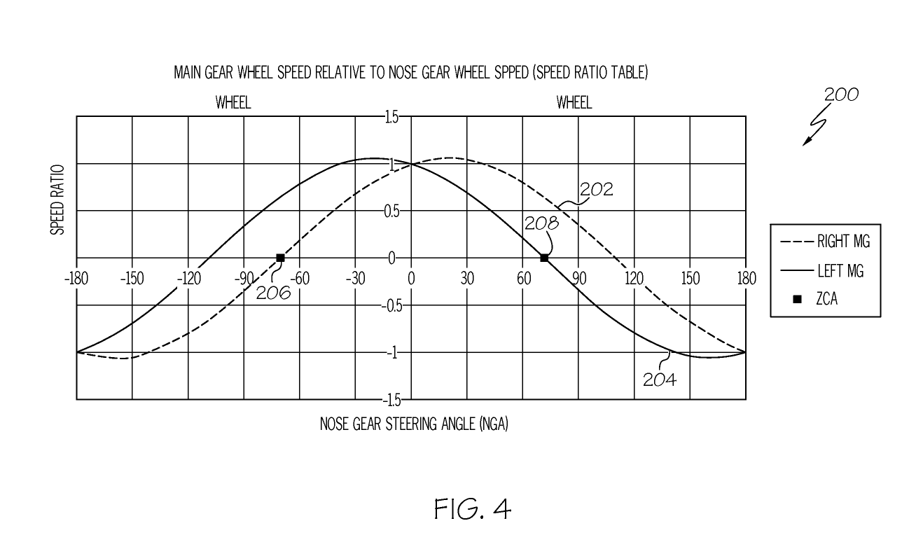

Referring now to FIG. 3, a diagram 160 illustrates interactions of the nose wheel 118 and the MG wheels 132 and 133 during a pivot turn maneuver performed in accordance with an exemplary embodiment of the invention. The nose wheel 118 may be turned so that the NGA may be equal to a zero crossing angle described in FIG. 4 (i.e., a nose wheel angle for which one MG wheel speed is zero). An acceleration indicator line 153 may represent yaw acceleration of the nose wheel 118. The acceleration indicator line 153 is illustrated in an orientation that is orthogonal to the axis 154 of the nose wheel 118. In other words, the relative speeds of the left MG and right MG may be controlled so that the nose wheel 118 may not be subjected to any axial (i.e., lateral) forces resulting from yaw acceleration of the aircraft.

Referring now to FIG. 4, a graph 200 illustrates various operational aspects of an exemplary embodiment of the speed ratio table 108 of FIG. 1. A first curve 202 illustrates right main gear wheel speed relative to nose wheel speed as a function of NGA. A second curve 204 illustrates left main gear wheel speed relative to nose wheel speed as a function of NGA. A first point 206 illustrates a zero crossing angle (ZCA) for the right MG. A second point 208 illustrates a zero crossing angle (ZCA) for the left MG.

The relationships illustrated in the graph 200 may be characterized with the expressions:

RMG speed ratio=AMP*sin(ZCA+NGA); and (1)

LMG speed ratio=AMP*sin(ZCA−NGA) (2)

Where ZCA=90°−a tan(D/L/2); (3)

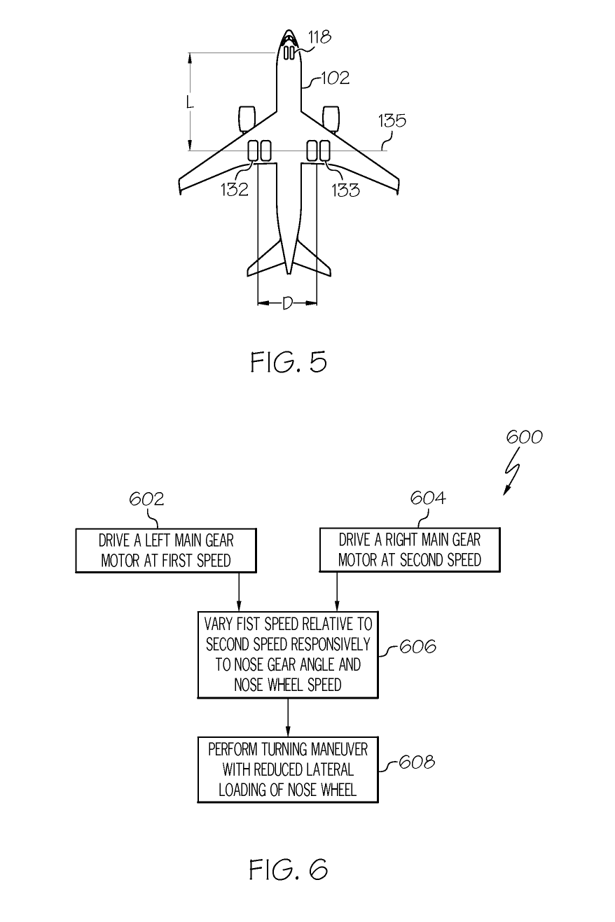

AMP (amplitude)=1/sin(ZCA); (4)
L=wheel base length (see FIG. 5); and
D=main gear separation (See FIG. 5).

FIG. 5 shows a plan view of the aircraft 102 and illustrate geometric features of the aircraft that are relevant to the speed ratio table 108. A letter L designates spacing between the nose wheel 118 and an axial line 135 passing through the MG wheels 132 and 133. A letter D designates spacing between the MG wheels 132 and 133 along the axial line 135.

It may be noted that under prior art operating procedures aircraft steering is limited to a nose gear angle of 60 degrees. Employment of the steering system 100 may safely allow sharper steering. In fact, 90 degrees of steering angle may allow for rotation or pivoting of the aircraft 102 about the point that is midway between the left and right main gear wheels 132 and 133. The system 100 may also allow for reverse aircraft motion while still achieving reduced lateral loading on the nose wheel 118 because a neutral nose gear angle is considered to be plus or minus 180 degrees according to the speed ratio table 108.

Referring back to FIG. 1, it may be seen that the PD filters 110 and 112 receive the LTC 140 and the RTC 142 respectively. The PD filters 110 and 112 may determine yaw acceleration in accordance with the following expression:

dYaw_rate/dt=d(steering angle*velocity)/dt=d(NGA*NGS)/dt=dNGA/dt*NGS+dNGS/dt*NGA (5)

Where:

NGA=nose gear angle; and

NGS=nose wheel speed.

Additionally, aircraft fuel load, passenger count and cargo weight can be accounted for in a yaw inertia term which may be incorporated as a factor in differential torque required to accelerate and decelerate the aircraft 102 in the yaw axis. This factor may be applied as a scalar multiplier of the differential term of the PD filters 110 and 112. The PD filters 110 and 112 may account for continuous changes in nose gear speed and turning angle.

The motor drive signals 144 and 146 may be continuously provided to the controllers 114 and 116 so that the MG drive wheels 132 and 133 impart most of the torque required to perform a turning maneuver. It may be noted that if the motor drive signals 144 and/or 146 produce power demands that exceeds power availability, the commanded power may be scaled back to such a degree as to no longer exceed the available supply power.

Referring now to FIG. 6, a flow chart illustrates an exemplary embodiment of a method 600 for turning an aircraft during taxiing. In a step 602, a left MG motor may be driven at a first speed (e.g. the motor 128 may be driven in response to the left MG torque application signal 124). In a step 604, a right MG motor may be driven at a second speed (e.g. the motor 130 may be driven in response to the right MG torque application signal 126). In a step 606, the first speed may be varied relative to the second speed responsively to NGA and NGS (e.g., variations of speed may be developed through use of the speed ratio table 108 and the PD filters 110 and 112). In a step 608 turning of the aircraft may be performed with reduced lateral loading of a nose wheel

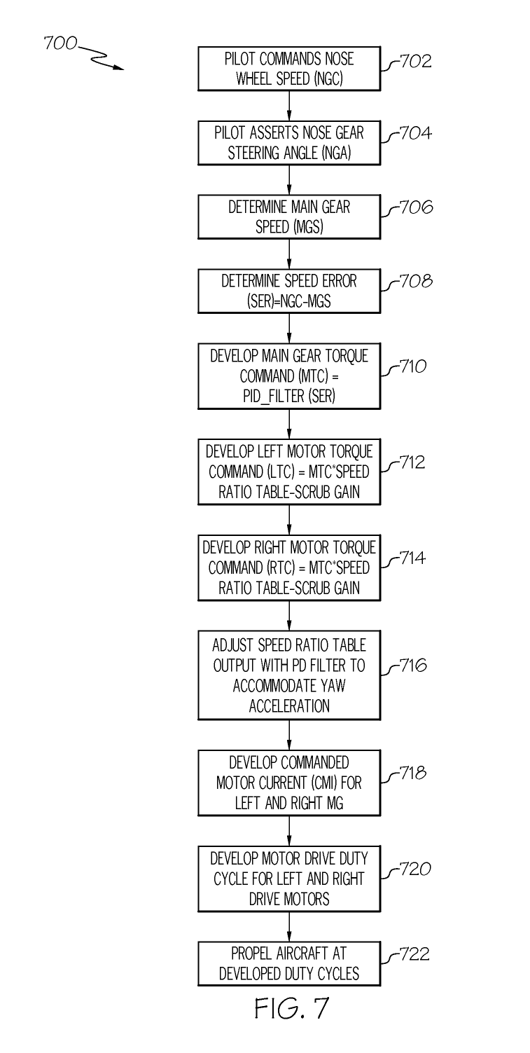

Referring now to FIG. 7, a flow chart illustrates an exemplary embodiment of a method for controlling an aircraft during ground based operation. In a step 702, a pilot may command nose wheel speed (NGC). In a step 704, the pilot may assert nose gear steering angle (NGA). In a step 706, main gear speed (MGS) may be determined. In a step 708, speed error (SER) may be determined (e.g., SER=NGC−MGS). In a step 710, main gear torque command (MTC) may be determined (e.g., MTC=SER applied to PID filter 106). In a step 712, left motor torque command (LTC) may be determined (e.g., LTC=MTC applied to speed ratio table 108). In a step 714, right motor torque command (RTC) may be determined (e.g., RTC=MTC applied to speed ratio table 108). In a step 716, speed ratio table output may be adjusted with PD filter to accommodate yaw acceleration (e.g., output of table 108 adjusted with PD filters 110 and 112). In a step 718, commanded motor current (CMI) for left and right MG may be developed. In a step 720, motor drive duty cycle for left and right drive motors may be developed. In a step 722, aircraft may be propelled through a turning maneuver at developed duty cycles.

It should be understood, of course, that the foregoing relates to exemplary embodiments of the invention and that modifications may be made without departing from the spirit and scope of the invention as set forth in the following claims.

We claim:

1. An aircraft taxi control system comprising:
a left main gear (MG) drive motor;
a right MG drive motor;
a first motor drive controller configured to produce a left motor torque application signal responsively to nose gear angle (NGA) and nose wheel speed (NGS); and
a second motor drive controller configured to produce a right motor torque application signal responsively to the NGA and the NGS,
said left motor torque application signal and said right motor torque application signal being coordinated to reduce lateral loading of a nose wheel during a turning maneuver.

2. The taxi control system of claim 1 wherein said left motor torque application signal and said right motor torque application signal are coordinated to produce acceleration of the nose wheel only in a direction orthogonal to an axis of the nose wheel during a turning maneuver.

3. The taxi control system of claim 1 further comprising a speed ratio table configured to determine speeds of each of the MG drive motors relative to NGA and NGS.

4. The taxi control system of claim 3 wherein the speed ratio table embodies the expressions:
Right MG wheel speed ratio=AMP*sin(ZCA+NGA); and
Left MG wheel speed ratio=AMP*sin(ZCA−NGA)
where ZCA (Zero crossing angle)=90°−a tan(D/L/2);
AMP (amplitude)=1/sin(ZCA);
L=wheel base length; and
D=main gear separation.

5. The taxi control system of claim 1 further comprising at least one proportional differential (PD) filter configured to receive a turning torque command and provide a motor drive signal to one of the motor drive controllers.

6. The taxi control system of claim 5 wherein the at least one PD filter embodies the expression:
Yaw acceleration=dYaw_rate/dt=d(steering angle*velocity)/dt=d(NGA*NGS)/dt=dNGA/dt*NGS+dNGS/dt*NGA;
where:
NGA=nose gear angle; and
NGS=nose wheel speed.

7. The taxi control system of claim 6 wherein aircraft fuel load is incorporated as a scalar multiplier of a differential term of the PD filter.

8. The taxi control system of claim 1 further comprising:
a first proportional differential (PD) filter configured to receive a first turning torque command and provide a motor drive signal to the first motor drive controller; and
a second PD filter configured to receive a second turning torque command and provide a second motor drive signal to the second motor drive controller.

9. A method for turning an aircraft during taxiing comprising the steps:
driving a left MG motor at a first speed;
driving a right MG motor at a second speed; and
varying the first speed relative to the second speed responsively to NGA and NGS to reduce lateral loading of the nose wheel resulting from yaw acceleration of the aircraft during a turning maneuver.

10. The method of claim 9 further comprising the steps:
continuously calculating yaw acceleration of the aircraft during the turning maneuver; and
continuously varying the first speed relative to the second speed responsively to the calculated yaw acceleration.

11. The method of claim 10 wherein the step of continuously varying the first speed relative to the second speed responsively to the calculated yaw acceleration produces acceleration of the nose wheel only in a direction orthogonal to an axis of the nose wheel.

12. The method of claim 10 wherein the step of calculating yaw acceleration is performed in accordance with the expression:
Yaw acceleration=dYaw_rate/dt=d(steering angle*velocity)/dt=d(NGA*NGS)/dt=dNGA/dt*NGS+dNGS/dt*NGA;
where:
NGA=nose gear angle; and
NGS=nose wheel speed.

13. The method of claim of claim 10 wherein the step of calculating yaw acceleration is performed in a proportional differential (PD) filter.

14. The method of claim 10 further comprising the step producing a motor drive signal with the PD filter.

15. The method of claim 10 further comprising incorporating aircraft fuel load as a scalar multiplier of a differential term of the PD filter.

16. A method for controlling an aircraft during ground based operation comprising the steps:
producing a motor torque command (MTC) from a nose gear speed command (NGC);
producing a nose gear angle command (NGA);
applying the MTC and the NGA to a speed ratio table to produce a left torque command (LTC) and a right torque command (RTC) as a function of aircraft geometry;
producing a left MG torque application command;
producing a right MG torque application command;
driving a left MG drive motor responsively to the left MG torque application command; and
driving a right MG drive motor responsively to the right MG torque application command,
so that the aircraft turns responsively to the NGA command with reduced lateral loading of a nose wheel resulting from yaw acceleration of the aircraft.

17. The method of claim 16 wherein the steps of driving the left MG motor and driving the right MG motor to produce acceleration of the nose wheel only in a direction orthogonal to an axis of the nose wheel.

18. The method of claim 16 further comprising the steps of:
orienting the nose wheel of the aircraft at a zero crossing angle; and
driving a first set of MG wheels to produce acceleration of the nose wheel only in a direction orthogonal to an axis of a nose wheel of the aircraft while the aircraft pivots around a second set of MG wheels.

19. The method of claim 16 further comprising the step of developing commanded motor current for the left and right MG drive motors.

20. The method of claim 19 further comprising the step of developing motor drive duty cycles for the left and right MG drive motors.
